(19) United States
(12) Patent Application Publication
(10) Pub. No.: US 2025/0086521 A1
(43) Pub. Date: Mar. 13, 2025

(54) SYSTEMS AND METHODS FOR DETECTING ANOMALOUS DATA IN FEDERATED LEARNING USING HISTORICAL DATA PROFILES

(71) Applicant: Capital One Services, LLC, McLean, VA (US)

(72) Inventors: Tyler FARNAN, San Diego, CA (US); Jeremy GOODSITT, Champaign, IL (US); Michael DAVIS, Arlington, VA (US); Taylor TURNER, Richmond, VA (US); Areal TAL, McLean, VA (US); Kenny BEAN, Herndon, VA (US)

(73) Assignee: Capital One Services, LLC, McLean, VA (US)

(21) Appl. No.: 18/462,717

(22) Filed: Sep. 7, 2023

(51) Int. Cl. G06N 20/20

(52) U.S. Cl. CPC G06N 20/20

(57) ABSTRACT

Systems and methods for detecting anomalous data updates in federated learning. In some aspects, the system retrieves a plurality of data updates and a corresponding plurality of data profiles during a first interval of time. The system generates a first data profile trend based on the plurality of data profiles, including an expectation value and a measure of variance. The system receives a subsequent data update and a corresponding subsequent data profile. The system determines a measure of deviation based on the expectation value of the first data profile trend and the subsequent data profile. The system generates an anomaly score based on the measure of deviation and the measure of variance. Based on the anomaly score, the system determines whether to label the subsequent data update as acceptable for inclusion in training data to generate a local model.

### SUMMARY

Federated machine learning is a machine learning technique in which the algorithm trains across multiple decentralized client devices each with a distinct training dataset. This allows client devices to collectively train a shared machine learning model. Each client device trains a local model then sends a set of model weights to the cloud (e.g., a central node of the federated learning system), wherein it is merged with weights from other local models to improve the shared model. However, federated machine learning is not without challenges. In particular, current federated learning systems lack clarity in addressing the problem of detecting bad quality or anomalous training data for federated learning. If a set of training data or a client device has been compromised, the undesirable parameters trained at that device in that batch of local models could poison the shared model.

Methods and systems are described herein for novel uses and/or improvements to artificial intelligence applications and in particular to detecting anomalous data in federated learning using historical data profiles and/or topological data analysis. Inaccurate training data may be introduced maliciously in an attempt to sabotage the training process. Alternatively, data can be corrupted on the client device due to hardware or software problems resulting in processing or storage errors. To address these data quality problems, methods and systems herein use historical data profiles and/or topological data analysis to identify problematic data before the local model is trained. Doing so protects the local model against compromised data and therefore presents a more accurate set of parameters for the shared model. In addition, filtering the training data at the client device level protects privacy compared to solutions that send training data to the central node for review.

Existing federated learning systems lack methods to ensure the integrity of the training data used at the client device prior to training the local model. Conventional systems have not considered using historical data profiles of training data from past training episodes to establish an expectation of incoming training data. The expectation may be used in combination with an acceptable extent of variance to enforce guidelines on the drift of training data in certain dimensions.

Conventional systems have also not contemplated leveraging topological data analysis techniques for the detection of anomalous data updates in the context of training data for federated learning. While a conventional system for outlier detection might use simple techniques like fixed cutoffs for certain metrics describing data updates to determine abnormality, such techniques are not the most accurately attuned to the local circumstances and purposes of data updates. Such techniques are inflexible and therefore prone to error.

Therefore, the difficulty in using machine learning to detect anomalous data updates faces several technical challenges such as the high dimensionality of raw data, which causes a lack of clarity regarding the relative importance of features of data updates for abnormality, and a difficulty in distinguishing outlier among data updates when many dimensions of an abnormal data update may appear unremarkable. To overcome these technical deficiencies in adapting artificial intelligence models for this practical benefit, methods and systems disclosed herein utilize topological data analysis to detect anomalous data updates, which is especially well-suited to high-dimensional data and finely distinguishes outliers from data patterns and topological invariants. Additionally or alternatively, methods and systems disclosed herein generate data profiles based on data updates, which capture the most salient features of the data updates where deviation is most likely to be indicative of data being compromised.

Thus, methods and systems disclosed herein are better able to capture patterns of data in a succinct, pertinent and accurate manner and therefore detect abnormal data updates with greater reliability and accuracy.

In some aspects, the techniques described herein relate to a method for detecting anomalous data updates on a client device in a federated learning system, including: during a first interval of time, retrieving a plurality of data updates and a corresponding plurality of data profiles; generating a first data profile trend based on the plurality of data profiles, wherein the first data profile trend includes an expectation value and a measure of variance; receiving a subsequent data update and a corresponding subsequent data profile; determining a measure of deviation based on the expectation value of the first data profile trend and the subsequent data profile; generating an anomaly score based on the measure of deviation and the measure of variance; and based on the anomaly score, determining whether to label the subsequent data update as acceptable for inclusion in training data to generate a local model.

In some aspects, methods and systems are described herein comprising: receiving a plurality of data updates, wherein each data update contains data in a first real-valued space; selecting a first function to project the plurality of data updates into a second real-valued space; selecting a second function to partition the second real-valued space into a plurality of sectors; generating a plurality of sector datasets associated with the plurality of sectors; processing the plurality of sector datasets to generate a relational data structure; and determining one or more outliers in the relational data structure corresponding to anomalous data updates.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for detecting anomalous data updates, in accordance with one or more embodiments.

FIG. 2 shows an illustration of an embedding map projecting data into an alternate real-valued space, in accordance with one or more embodiments.

FIG. 3 shows illustrative components for a system for detecting anomalous data updates, in accordance with one or more embodiments.

FIG. 4 shows a flowchart of the steps involved in detecting anomalous data updates using topological data analysis, in accordance with one or more embodiments.

FIG. 5 shows a flowchart of the steps involved in detecting anomalous data updates using historical data profiles, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

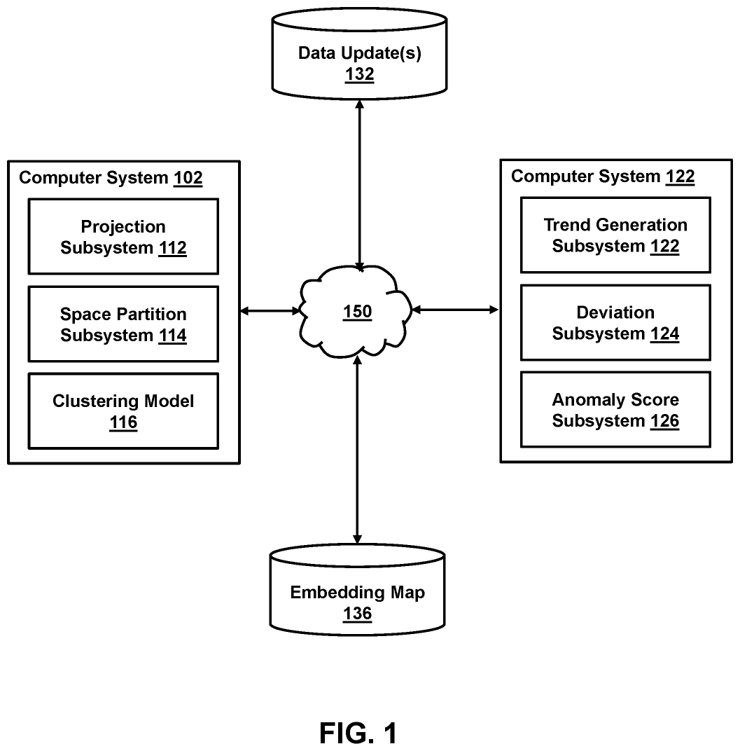

FIG. 1 shows an illustrative diagram for system 150, which contains hardware and software components used for detecting anomalous data updates, in accordance with one or more embodiments. For example, Computer System 102, a part of system 150, may include Projection Subsystem 112, Space Partition Subsystem 114, and Clustering Model 116. In some embodiments, the components of system 150 may be stored on a client device in a federated learning system. The client device may use training data to train a local model for the federated learning system. The local model may contain a set of parameters describing the local model. The client device may transmit the parameters describing the local model to a central node of the federated learning system, where the parameters may be used for reference in a central model. For example, a healthcare provider may train a disease diagnosis or prognosis machine learning model, and patient health data may be among the training inputs of said model. However, to protect patient privacy, the health data could not be shared to a central node for collectivized training. Instead, each client device may use what patient health data is available at the client device to train a local model, e.g., a neural network. Each client device can then send sets of weights representing the local models to a central repository, where the weights can be combined to generate a central model without disclosing patient data to the central node.

System 150 (the system) may retrieve a plurality of data updates (e.g., Data Update(s) 132) on a client device. The plurality of data updates may, for example, be meant as training data for a federated learning system. Each user profile in Data Update(s) 132 corresponds to a user system, and contains information described by a first set of features. The first set of features may contain categorical or quantitative variables, and values for such features may describe, for example for models predicting resource availability values, the user system's make and model, the user system's location, the membership of the user system in any networks, any allocations of resources to the user system, a length of time for which the user system has recorded resource consumption, an extent and frequency of resource consumption, and the number of instances of the user system's excessive resource consumption. Each user profile may correspond to a resource availability value indicating the current amount of resources that should be made available to or reserved for the user system, which may also be recorded in Data Update(s) 132 in association with the user profile. The system may retrieve a plurality of user profiles as a matrix including vectors of feature values for the first set of features and append to the end of each vector a resource consumption value.

In some embodiments, the system may, before retrieving data updates, process Data Update(s) 132 using a data cleansing process to generate a processed dataset. The data cleansing process may include standardizing data types, formatting and units of measurement, and removing duplicate data. The system may then retrieve vectors corresponding to user profiles from the processed dataset.

In some embodiments, the system may process Data Update(s) 132 to generate data profiles, each of which correspond to a data update. A data profile describing a data update (e.g., including a first set of features) may include descriptive statistics regarding the data update. For example, the data profile may include a vector of averages across the first set of features in the data update. For example, the data profile may include distributions of the first set of features in the data update. For example, the data profile may include a list of frequencies of null values for the first set of features. For example, the data profile may include a covariance matrix between the first set of features. In some embodiments, the data profile may additionally or alternatively project datasets in Data Update(s) 132 into an alternate coordinate system, for example using Embedding Map 136. In some embodiments, the system may receive Data Update(s) 132 as a stream of data updates over a period of time, each data update including a unique dataset, for example representing a snapshot of some evolving process such as a disease. Correspondingly, the plurality of data updates in Data Update(s) 132 represents changes to the training data for the local model over time.

In some embodiments, the system may process Data Update(s) 132 and/or its corresponding data profiles using an extrapolation model (e.g., Trend Generation Subsystem 122) to generate a data profile trend. The data profile trend may include an expectation value and a measure of variance. The expectation value may be a vector of real values corresponding to a set of features from the plurality of data updates and the plurality of data profiles. The measure of variance may be a vector of real values, where each value is derived from a standard deviation of a feature in the set of features. Therefore, the data profile trend may capture the expected values and expected variances for some or all of the features in the Data Update(s) 132 independently. This allows for the comparison of any incoming data update against each feature in the set of features, leading to a more accurate assessment of the source and type of any abnormalities in the incoming data update.

To generate the expectation value and the measure of variance, Trend Generation Subsystem 122 may use extrapolation machine learning models. For example, the extrapolation machine learning models may use algorithms like Bayesian regression, time-series regression and/or principal component analysis. The extrapolation machine learning models may take the data profiles of Data Update(s) 132 as input and may output predicted values for a set of features, each predicted value corresponding to a range of error. Thus, Trend Generation Subsystem 122 may take the predicted values as the expectation value, and the ranges of error as measures of variance. In some embodiments, the maximum value for a measure of variance may be limited as a percentile of the standard deviations of Data Update(s) 132.

In some embodiments, the data profile trend may be generated using topological data analysis. For example, Trend Generation Subsystem 122 may select a lens function to project the plurality of data profiles into a real-valued space. For example, Trend Generation Subsystem 122 may choose a real-valued embedding space with a set of dimensions different from those used in data profiles for Data Update(s) 132. Thus, data profiles may be represented using embeddings in a lower dimension while preserving similarity relations within the data profiles. Trend Generation Subsystem 122 may then select a cover function to partition the real-valued embedding space into a plurality of overlapping sectors. Each sector in the real-valued embedding space may contain data profile representations, which may be collected in sector datasets. The system can generate the data profile trend as a relational data structure, using the overlap relations between sector datasets. The process of topological data analysis is described in more detail below.

Subsequent to generating the data profile trend, the system may receive a subsequent data update and a corresponding subsequent data profile. The subsequent data update may include the same set of features as the data updates in Data Update(s) 132 and be of the same format. The subsequent data profile may also be in the same format and correspond to the same features as the data profiles for Data Update(s) 132. The data profile may include, for example, average values for the set of features, variance for each of the features in the subsequent data update, among other descriptive statistics. The system may determine a measure of deviation (e.g., using Deviation Subsystem 124) based on the expectation value of the data profile trend and the subsequent data profile. For example, if the expectation value is a vector of predicted values from extrapolation machine learning models, Deviation Subsystem 124 may compare the average values for the set of features in the subsequent data profile against the expectation value to generate the measure of deviation, where the measure of deviation is a vector of values capturing the numerical difference between the expectation value and the subsequent data profile in each feature. In some embodiments, the data profile trend is a relational data structure constructed using a lens function and a cover function which partitions data profile representations into sector datasets. Deviation Subsystem 124 may project the subsequent data profile into the real-valued embedding space using the lens function. Then, using the cover function, Deviation Subsystem 124 may assign the subsequent data profile to a first sector dataset associated with a first sector. Using the first sector dataset, the position of the subsequent data profile's representation within the first sector dataset, and the data profile trend, Deviation Subsystem 124 may determine a measure of deviation for the subsequent data profile. For example, the data profile trend may inform Deviation Subsystem 124 whether the first sector dataset contains outliers and/or the degree of separation from the first sector dataset to the relational data structure. In some embodiments, the measure of deviation of the subsequent data profile may be a vector, each value within which indicates a degree of deviation in one feature in the set of features in the subsequent data update. In other embodiments, the measure of deviation of the subsequent data profile may be a single real value.

The system (e.g., using Anomaly Score Subsystem 126) may generate an anomaly score based on the measure of deviation and the measure of variance. In some embodiments, the measure of deviation and the measure of variance are both vectors, each value in which corresponds to a feature in the subsequent data update. Anomaly Score Subsystem 126 may use a clustering machine learning model to process the measure of deviation and the measure of variance to generate the anomaly score. For example, the clustering model may take the measure of deviation, the expectation value and the measure of variance as input and generate as output a numerical score (the anomaly score) indicating the extent to which the measure of deviation falls within the measure of variance. The clustering model may use algorithms such as logistic regression, neural networks, and naïve bayes. In other embodiments, the measure of deviation and the measure of variance are both real values. Anomaly Score Subsystem 126 may determine the anomaly score to be a mathematical calculation based on the measure of deviation and the measure of variance (e.g., a proportion of the measure of deviation in the measure of variance.

Based on the anomaly score, the system may determine whether to label the subsequent data update as acceptable for inclusion in training data to generate a local model. For example, the system may receive an anomaly threshold from a central node of the federated learning system. The anomaly threshold may be a real value indicative of a benchmark degree of anomaly, beyond which data updates are to be rejected. If the anomaly score determined for the subsequent data update exceeds the anomaly threshold, the system may label the subsequent data update as unacceptable for inclusion in training data to generate a local model. Then the system may remove the subsequent data update and the subsequent data profile from a memory of the client device and train the local model based on Data Update(s) 132. If the anomaly score determined for the subsequent data update is less than the anomaly threshold, the system may use the subsequent data update for training the local model.

In some embodiments, the system may rely on topological data analysis to identify anomalous data updates, using Computer System 102. System 150 (the system) may retrieve a plurality of data updates (e.g., Data Update(s) 132) on a client device in order to train a local model. Data Update(s) 132 may include data updates with a first set of features in a first real-valued space. In some embodiments, Data Update(s) 132 may be split into multiple time-sequenced datasets. For example, each update within Data Update(s) 132 may correspond with a timestamp, and Data Update(s) 132 is separated into time-sequenced datasets with distinct timestamps for data contained within each time-sequenced dataset. Alternatively or additionally, data may be grouped into a time-sequenced dataset based on an origin of the data update (e.g., a client device or a particular IP address). Data within all time-sequenced datasets may all be represented in the first real-valued space. For example, the first real-valued space may contain a number of dimensions equal to the number of features in the first set of features. In some embodiments, the system may generate data profiles based on Data Update(s) 132. For example, the data profile may include a vector of averages across the first set of features in the data update. For example, the data profile may include distributions of the first set of features in the data update. For example, the data profile may include a list of frequencies of null values for the first set of features. For example, the data profile may include a covariance matrix between the first set of features.

The system may use a lens function (e.g., Projection Subsystem 112) to project the plurality of data updates, including data points in a first real-valued space corresponding to a first set of features, into a second real-valued space. For example, Projection Subsystem 112 may normalize the data points within data updates to a standard-deviation space. A value for a feature in the first set of features is represented in the standard deviation space with a z-score, corresponding to the difference between the value and the mean for the feature divided by the standard deviation of the feature. Additionally or alternatively, Projection Subsystem 112 may generate a covariance matrix based on the first set of features. The covariance matrix captures how features within the first set of features correlate to each other. Projection Subsystem 112 may then compute a set of eigenvectors and eigenvalues for the covariance matrix (e.g., through the Singular Value Decomposition method). Each eigenvector corresponds to an eigenvalue and represents a feature in the first set of features. The relative proportions of the eigenvalues are directly correlated with the relative prominence of features within the first set of features, as measured by the proportion of variation within other features attributed to a feature. Projection Subsystem 112 may then select a measure of coverage (e.g., a threshold percentage of the explanative power of the model). Using the measure of coverage, Projection Subsystem 112 may select a subset of eigenvectors from the set of eigenvectors. For example, if the measure of coverage is 55%, and three eigenvectors' eigenvalues add up to 56% when normalized, Projection Subsystem 112 may select the three eigenvectors. Projection Subsystem 112 may then determine a second set of features to correspond to the subset of eigenvectors. The second real-valued space may contain dimensions corresponding to the second set of features. In some embodiments, the system may use a representation machine learning model to process data profiles representing Data Update(s) 132 to generate representation vectors in the second real-valued space.

Having selected a second set of features, the system may generate an encoding map to translate values for the first set of features into the second set of features. The encoding map may be a series of rules and transformations that take a vector of input data (e.g., values for features in the first set of features), applies mathematical transformations like weight multiplications and Boolean combinations to the vector of input data, and produces an output vector which represents feature values for the second set of features. For example, an input vector of the values [23, 0.7, 100, 66, 80.4] may be taken into an encoding map. The encoding map may multiply the first feature by 1.774 to obtain the first output value. The encoding map may determine whether the second feature is greater than 0.5: if it is, the second output value is set to 1 and if not, it is set to 0. The encoding map may calculate a difference between the third and fourth features (e.g., 34) to be the third output value. The encoding map may ignore the fifth feature. Thus, the encoding map in this example takes an input vector of [23, 0.7, 100, 66, 80.4] and outputs a vector of values [40.802, 1, 34]. In another example, an encoding map may translate categorical variables. For example, the feature of “industry group” with the value of “real estate” may be represented as 503 in the output. The encoding map may store weights, rules, and other information in hardware and/or software.

After generating representations for Data Update(s) 132 in the second real-valued space, the system may select a cover function (e.g., Space Partition Subsystem 114) to partition the second real-valued space into a plurality of regions defined by boundary parameters. For example, the regions may be initially set as equal-length partitions of each dimension within the second real-valued space. For example, the second real-valued space may be defined as three dimensions between the points (0, 100, 200) and (50, 150, 250) and may be divided into two regions. One region may have the boundary parameters (0, 100, 200) to (35, 135, 235), and the other region may have the boundary parameters (15, 115, 215) to (50, 150, 250). Each region may contain one or more data representations in the second real-valued space. Space Partition Subsystem 114 may adjust the boundary parameters of regions based on criteria such as the density of data in each region. For example, Space Partition Subsystem 114 may determine a density of data for each region, and compare each density against a threshold density. For any region below the threshold density, Space Partition Subsystem 114 may expand the boundary parameters of the region until it meets the threshold. Additionally or alternatively, Space Partition Subsystem 114 may expand boundary parameters of regions based on a proportion of overlap data. Space Partition Subsystem 114 may determine a plurality of overlap data among the regions, where overlap data belong in more than one region. In the above example, data in the range of (15, 115, 215) to (35, 135, 235) would be overlap data. Space Partition Subsystem 114 may determine a percentage of overlap data among all data within each region and compare the percentages against a threshold proportion. For any region below the threshold proportion, Space Partition Subsystem 114 may expand the boundary parameters of the region until it meets the threshold. After each region meets one or both thresholds, Space Partition Subsystem 114 may determine the plurality of regions with adjusted boundary parameters to be the plurality of sectors.

Space Partition Subsystem 114 may then generate a plurality of sector datasets. Each sector dataset corresponds to a sector and contains data in the first real-valued space associated with the data representations in the sector in the second real-valued space. For example, Space Partition Subsystem 114 may project the data in the sector from the second real-valued space back into the first real-valued space using a reverse of the process in Embedding Map 136. That is, sector datasets contain data from Data Update(s) 132. Due to the sectors in the second real-valued space including overlap data, some data from Data Update(s) 132 may be assigned to multiple sector datasets. In some embodiments, the sector datasets may correspond with the set of time-sequenced datasets generated using Data Update(s) 132. For example, the plurality of sector datasets may be set as the set of time-sequenced datasets. Alternatively, the sector datasets may be generated in such a way that each sector dataset contains data simultaneously satisfying two conditions: firstly, that the data within the sector dataset have representations in the second real-valued space in the same sector, and secondly, that the data fall into the same time-sequenced dataset.

The system may then use the plurality of sector datasets to generate a relational data structure. For example, the system may use a clustering machine learning model (e.g., Clustering Model 116) to cluster data in each sector dataset into clusters. Clustering Model 116 may use algorithms such as K-means clustering, hierarchical clustering, and DBSCAN. Clustering Model 116 may take as input the data within a sector dataset, and output cluster assignments for each data point with the sector dataset. For example, a first sector dataset may have its data sorted into group A, group B, and group C. A second sector dataset may have its data sorted into group D and group E. For example, overlap data between the first sector dataset and the second sector dataset may be assigned to group B in the first sector dataset and to group E in the sector dataset. Based on the cluster assignments of data from Data Update(s) 132 and their respective memberships in one or more sector datasets, the system may generate a relational data structure. The relational data structure includes nodes and edges, where nodes may be each cluster assignment output by Clustering Model 116. In the above example, five nodes would correspond to group A, group B, group C, group D and group E. The system may connect edges between two nodes if the nodes originated from the same sector dataset. For example, group A would be connected to group B and group C, group B would be connected to group A and group C, and group C would be connected to group A and group B. Similarly, group D and group E are connected. Further, the system may create edges between two nodes if data exist within both nodes. In the above example, group B and group E may be connected with an edge due to overlap data being assigned to both groups. In some embodiments, the system may require a threshold number of overlap data points in order to connect two otherwise unconnected nodes with an edge.

Using the relational data structure, the system may determine one or more outlier nodes. For example, the system may calculate a degree of connectedness for each node within the relational data structure. In some embodiments, the system may select a depth number such that the degree of connectedness for a node may be the number of nodes connected to the node in question with a smaller or equal number of edges than the depth number. For example, node A may be connected through one edge to node B and through another node C. Additionally, node B may be connected through one edge to node D. Node D may be connected through one edge to node E. In this example, if the system selects a depth number of two, node A would have a degree of connected ness of three: node A is connected to node B, node C and node D with two edges or less. The system may select a threshold degree of connectedness, and label any node with less degrees of connectedness as outliers. The data updates(s) in Data Update(s) 132 corresponding to such outlier nodes may therefore be determined to be anomalous and rejected for training the local model.

In some embodiments, the system may determine anomalous or outlying data updates using the relational data structure by calculating similarity scores from a data update to one or more sector datasets. For example, the system may compute a similarity score indicating a distance from sector datasets associated with the data update to the closest sector dataset(s). The similarity score between one sector dataset and another may be computed using persistence diagrams generated from a mapper of the two sector datasets. For example, the system may generate a first persistence diagram based on the output of a mapper algorithm (such as the one described above) for the first sector dataset. The system may generate a second persistence diagram based on the output of the same mapper algorithm for the second sector dataset. The system may then compute a bottleneck distance between the first and second persistence diagrams indicative of the length of a longest edge between the first persistence diagram and the second persistence diagram. The bottleneck distance may be a real value between 0 and 1. The system may determine the similarity score between the first and second sector datasets to be one minus the bottleneck distance between the first and second persistence diagrams.

The system may determine whether a data update is an outlier using its similarity scores. For example, the system may compute an outlier score indicating a distance from sector datasets associated with the data update to all the other sector datasets. The outlier score for the data update in this example may be one minus the mean of all similarity scores associated with the data update. Alternatively, the system may compute an outlier score indicating a distance from sector datasets associated with the data update to the closest other sector dataset. In this example, the outlier score may be one minus the largest similarity score associated with the data update. The system may compare an outlier score associated with a data update to determine whether the data update is considered anomalous.

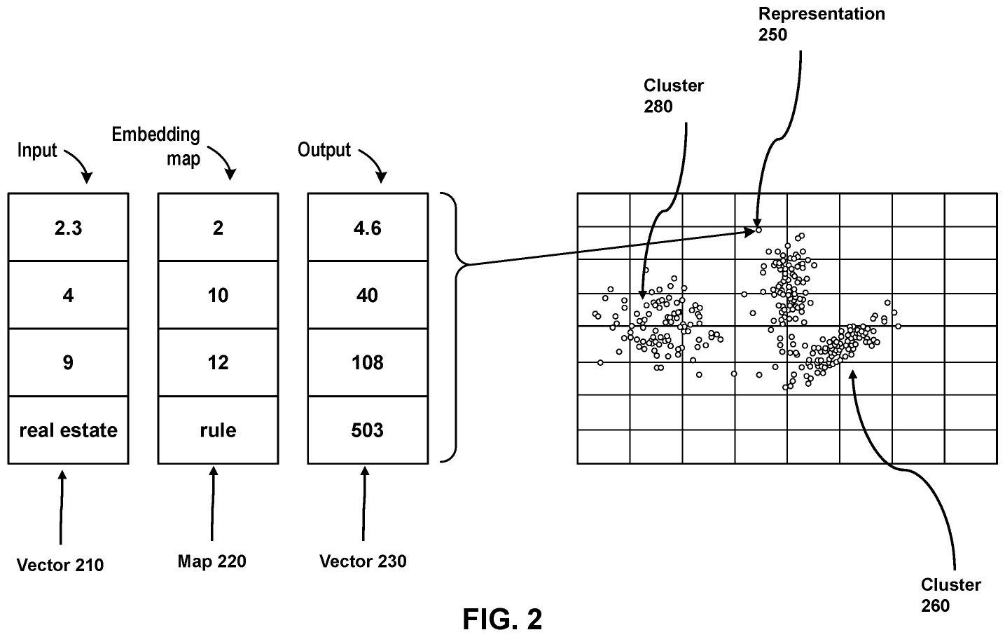

FIG. 2 is a demonstration of an embedding map (e.g., Embedding Map 136) transforming an input vector into an output vector which may be represented in a real-valued embedding space. The input vector, Vector 210, contains four values corresponding to four features which constitute the first set of features. For example, Vector 210 may represent a user profile for a commercial lending applicant, and the user may be a corporation. The features may be gross profit margin, lines of credit outstanding, free cash flow per annum, and the type of industry the user is in. The first three features are quantitative, and the fourth is categorical. Vector 210 shows values for each feature, namely [2.3, 4, 9, “real estate”]. Map 220 may transform Vector 210 and other vectors of feature values into embedded vectors like Vector 230. Map 220 contains a list of weights [2, 10, 12] and a rule for handling the categorical input. Map 220 may apply a weight multiplication onto the quantitative variables in Vector 210 to produce the values [4.6, 40, 108]. Then it may use the rule to translate “real estate” into 503. Therefore, the embedded Vector 230 includes [4.6, 40, 108, 503] and encapsulates the user profile in the real-valued embedding space. Representation 250 shows the user profile being compared alongside a plurality of other user profiles represented in the real-valued embedding space. A machine learning model (e.g., User Clustering Model 116) may have formed the plurality of user profiles into two clusters: Cluster 280 and Cluster 260.

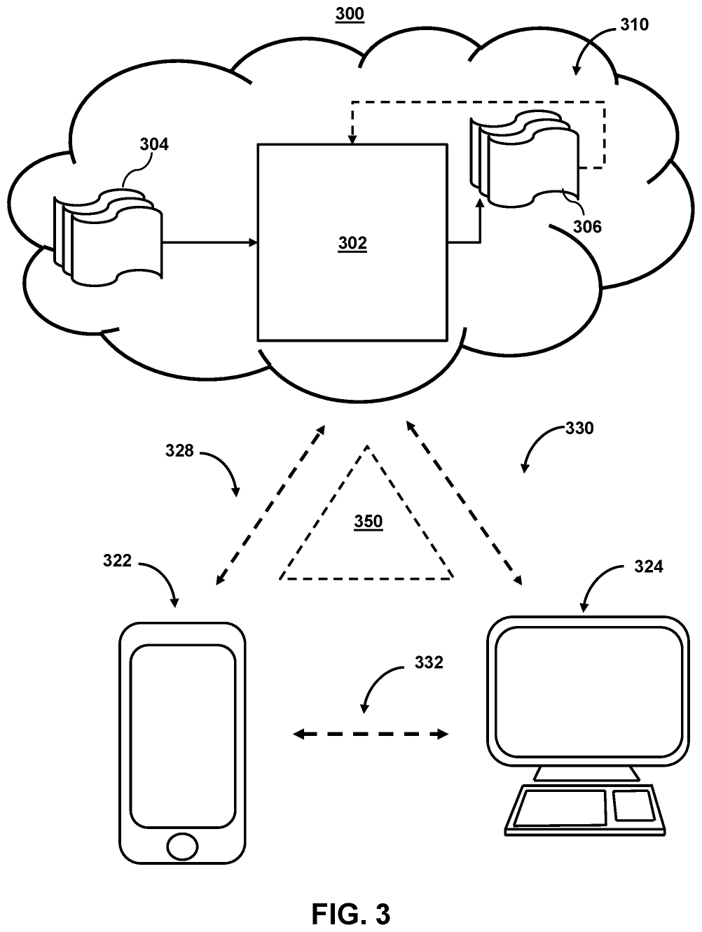

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict predicting resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

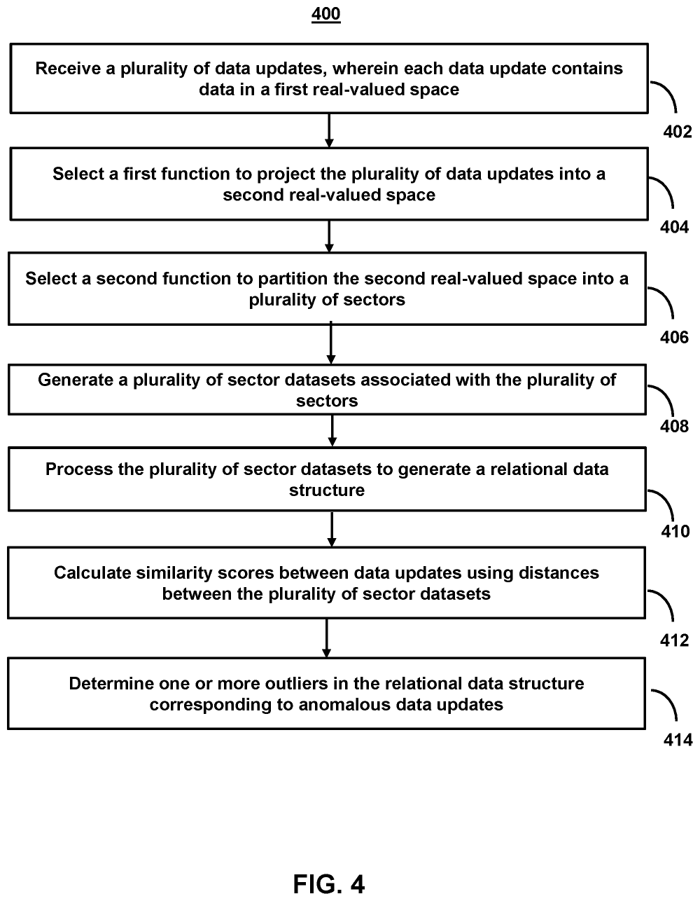

FIG. 4 shows a flowchart of the steps involved in detecting anomalous data submissions using topological data analysis, in accordance with one or more embodiments. For example, the system may use process 400 (e.g., as implemented on one or more system components described above) in order to detect anomalous data submissions using topological data analysis.

At step 402, process 400 (e.g., using one or more components described above) receives a plurality of data updates, wherein each data update contains data in a first real-valued space. The plurality of data updates (e.g., Data Update(s) 132) may, for example, be meant as training data for a federated learning system. Each user profile in Data Update(s) 132 corresponds to a user system, and contains information described by a first set of features. The first set of features may contain categorical or quantitative variables, and values for such features may describe, for example for models predicting resource availability values, the user system's make and model, the user system's location, the membership of the user system in any networks, any allocations of resources to the user system, a length of time for which the user system has recorded resource consumption, an extent and frequency of resource consumption, and the number of instances of the user system's excessive resource consumption. Each user profile may correspond to a resource availability value indicating the current amount of resources that should be made available to or reserved for the user system, which may also be recorded in Data Update(s) 132 in association with the user profile. The system may retrieve a plurality of user profiles as a matrix including vectors of feature values for the first set of features and append to the end of each vector a resource consumption value.

In some embodiments, the system may, before retrieving data updates, process Data Update(s) 132 using a data cleansing process to generate a processed dataset. The data cleansing process may include standardizing data types, formatting and units of measurement, and removing duplicate data. The system may then retrieve vectors corresponding to user profiles from the processed dataset.

At step 404, process 400 (e.g., using one or more components described above) selects a first function to project the plurality of data updates into a second real-valued space. The system may use a lens function (e.g., Projection Subsystem 112) to project the plurality of data updates, including data points in a first real-valued space corresponding to a first set of features, into a second real-valued space. For example, Projection Subsystem 112 may normalize the data points within data updates to a standard-deviation space. A value for a feature in the first set of features is represented in the standard deviation space with a z-score, corresponding to the difference between the value and the mean for the feature divided by the standard deviation of the feature. Additionally or alternatively, Projection Subsystem 112 may generate a covariance matrix based on the first set of features. The covariance matrix captures how features within the first set of features correlate to each other. Projection Subsystem 112 may then compute a set of eigenvectors and eigenvalues for the covariance matrix (e.g., through the Singular Value Decomposition method). Each eigenvector corresponds to an eigenvalue and represents a feature in the first set of features. The relative proportions of the eigenvalues are directly correlated with the relative prominence of features within the first set of features, as measured by the proportion of variation within other features attributed to a feature. Projection Subsystem 112 may then select a measure of coverage (e.g., a threshold percentage of the explanative power of the model). Using the measure of coverage, Projection Subsystem 112 may select a subset of eigenvectors from the set of eigenvectors. For example, if the measure of coverage is 55%, and three eigenvectors' eigenvalues add up to 56% when normalized, Projection Subsystem 112 may select the three eigenvectors. Projection Subsystem 112 may then determine a second set of features to correspond to the subset of eigenvectors. The second real-valued space may contain dimensions corresponding to the second set of features. In some embodiments, the system may use a representation machine learning model to process data profiles representing Data Update(s) 132 to generate representation vectors in the second real-valued space.

Having selected a second set of features, the system may generate an encoding map to translate values for the first set of features into the second set of features. The encoding map may be a series of rules and transformations that take a vector of input data (e.g., values for features in the first set of features), applies mathematical transformations like weight multiplications and Boolean combinations to the vector of input data, and produces an output vector which represents feature values for the second set of features. For example, an input vector of the values [23, 0.7, 100, 66, 80.4] may be taken into an encoding map. The encoding map may multiply the first feature by 1.774 to obtain the first output value. The encoding map may determine whether the second feature is greater than 0.5: if it is, the second output value is set to 1 and if not, it is set to 0. The encoding map may calculate a difference between the third and fourth features (e.g., 34) to be the third output value. The encoding map may ignore the fifth feature. Thus, the encoding map in this example takes an input vector of [23, 0.7, 100, 66, 80.4] and outputs a vector of values [40.802, 1, 34]. In another example, an encoding map may translate categorical variables. For example, the feature of “industry group” with the value of “real estate” may be represented as 503 in the output. The encoding map may store weights, rules, and other information in hardware and/or software.

At step 406, process 400 (e.g., using one or more components described above) selects a second function to partition the second real-valued space into a plurality of sectors. After generating representations for Data Update(s) 132 in the second real-valued space, the system may select a cover function (e.g., Space Partition Subsystem 114) to partition the second real-valued space into a plurality of regions defined by boundary parameters. For example, the regions may be initially set as equal-length partitions of each dimension within the second real-valued space. For example, the second real-valued space may be defined as three dimensions between the points (0, 100, 200) and (50, 150, 250) and may be divided into two regions. One region may have the boundary parameters (0, 100, 200) to (35, 135, 235), and the other region may have the boundary parameters (15, 115, 215) to (50, 150, 250). Each region may contain one or more data representations in the second real-valued space. Space Partition Subsystem 114 may adjust the boundary parameters of regions based on criteria such as the density of data in each region. For example, Space Partition Subsystem 114 may determine a density of data for each region, and compare each density against a threshold density. For any region below the threshold density, Space Partition Subsystem 114 may expand the boundary parameters of the region until it meets the threshold. Additionally or alternatively, Space Partition Subsystem 114 may expand boundary parameters of regions based on a proportion of overlap data. Space Partition Subsystem 114 may determine a plurality of overlap data among the regions, where overlap data belong in more than one region. In the above example, data in the range of (15, 115, 215) to (35, 135, 235) would be overlap data. Space Partition Subsystem 114 may determine a percentage of overlap data among all data within each region and compare the percentages against a threshold proportion. For any region below the threshold proportion, Space Partition Subsystem 114 may expand the boundary parameters of the region until it meets the threshold. After each region meets one or both thresholds, Space Partition Subsystem 114 may determine the plurality of regions with adjusted boundary parameters to be the plurality of overlapping sectors.

At step 408, process 400 (e.g., using one or more components described above) generates a plurality of sector datasets associated with the plurality of sectors. For example, the system may use Space Partition Subsystem 114 to generate a plurality of sector datasets. Each sector dataset corresponds to a sector and contains data in the first real-valued space associated with the data representations in the sector in the second real-valued space. For example, Space Partition Subsystem 114 may project the data in the sector from the second real-valued space back into the first real-valued space using a reverse of the process in Embedding Map 136. That is, sector datasets contain data from Data Update(s) 132. Due to the sectors in the second real-valued space including overlap data, some data from Data Update(s) 132 may be assigned to multiple sector datasets.

At step 410, process 400 (e.g., using one or more components described above) processes the plurality of sector datasets to generate a relational data structure. For example, the system may use a clustering machine learning model (e.g., Clustering Model 116) to cluster data in each sector dataset into clusters. Clustering Model 116 may use algorithms such as K-means clustering, hierarchical clustering, and DBSCAN. Clustering Model 116 may take as input the data within a sector dataset, and output cluster assignments for each data point with the sector dataset. For example, a first sector dataset may have its data sorted into group A, group B, and group C. A second sector dataset may have its data sorted into group D and group E. For example, overlap data between the first sector dataset and the second sector dataset may be assigned to group B in the first sector dataset and to group E in the sector dataset. Based on the cluster assignments of data from Data Update(s) 132 and their respective memberships in one or more sector datasets, the system may generate a relational data structure. The relational data structure includes nodes and edges, where nodes may be each cluster assignment output by Clustering Model 116. In the above example, five nodes would correspond to group A, group B, group C, group D and group E. The system may connect edges between two nodes if the nodes originated from the same sector dataset. For example, group A would be connected to group B and group C, group B would be connected to group A and group C, and group C would be connected to group A and group B. Similarly, group D and group E are connected. Further, the system may create edges between two nodes if data exist within both nodes. In the above example, group B and group E may be connected with an edge due to overlap data being assigned to both groups. In some embodiments, the system may require a threshold number of overlap data points in order to connect two otherwise unconnected nodes with an edge.

In some embodiments, a relational data structure may be generated from each sector dataset. For each sector dataset, the observations within that sector dataset may be clustered using the process above. Then the system may take the union of all clusters and treat each of the clusters as a node in the relational data structure. If an observation falls into more than one cluster, then those clusters share a member. If and only if two clusters share a member, an edge exists between those two nodes associated with those clusters. The resulting set of nodes and edges is a relational data structure, also referred to as a mapper. A relational data structure may be made of more than one connected component.

In some embodiments, the system may create sector datasets using a variety of metrics. For example, each data update in Data Update(s) 132 may be assigned to one sector dataset. Alternatively, data updates received from the same client device may be assigned to the same sector dataset. The system may group a set number of data updates to form one sector dataset. In some embodiments, the system may create a relational data structure using the above process for each sector dataset.

At step 412, process 400 (e.g., using one or more components described above) calculates similarity scores between data updates using distances between the plurality of sector datasets or relational data structures. In some embodiments, the system may determine anomalous or outlying data updates using the relational data structure by calculating similarity scores from a data update to one or more sector datasets or relational data structures. For example, the system may compute a similarity score indicating a distance from sector datasets or relational data structures associated with the data update to the closest sector dataset(s) or relational data structures. The similarity score between one sector dataset or relational data structure and another may be computed using persistence diagrams generated from a mapper of the two sector datasets. For example, the system may generate a first persistence diagram based on the output of a mapper algorithm (such as the one described above) for the first sector dataset. The system may generate a second persistence diagram based on the output of the same mapper algorithm for the second sector dataset. The system may then compute a bottleneck distance between the first and second persistence diagrams indicative of the length of a longest edge between the first persistence diagram and the second persistence diagram. The bottleneck distance may be a real value between 0 and 1. The system may determine the similarity score between the first and second sector datasets to be one minus the bottleneck distance between the first and second persistence diagrams.

At step 414, process 400 (e.g., using one or more components described above) determines one or more outliers in the relational data structure corresponding to anomalous data updates.

The system may determine whether a data update is an outlier using its similarity scores. For example, the system may compute an outlier score indicating a distance from sector datasets or relational data structures associated with the data update to all the other sector datasets or relational data structures. The outlier score for the data update in this example may be one minus the mean of all similarity scores associated with the data update. Alternatively, the system may compute an outlier score indicating a distance from sector datasets associated with the data update to the closest other sector dataset or relational data structure. In this example, the outlier score may be one minus the largest similarity score associated with the data update. The system may compare an outlier score associated with a data update to determine whether the data update is considered anomalous.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

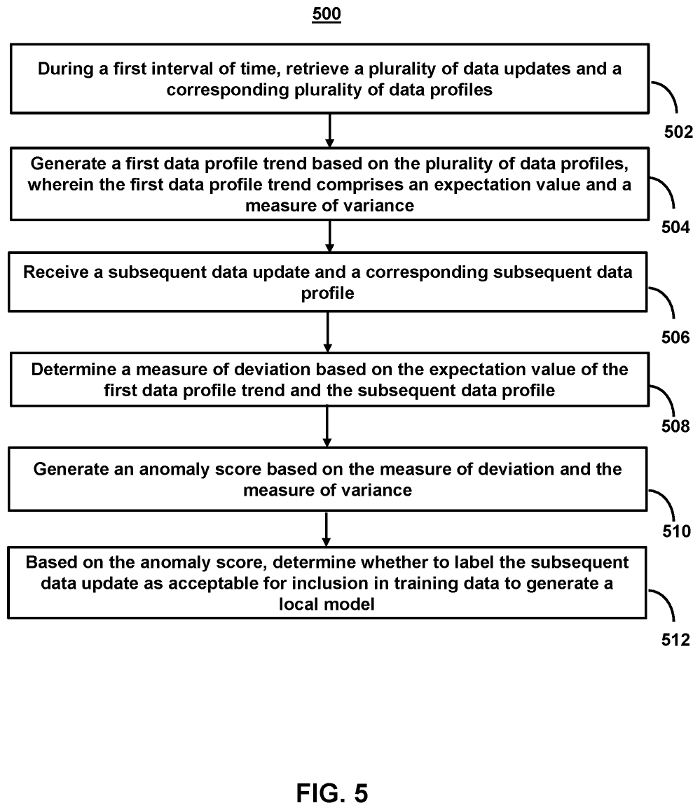

FIG. 5 shows a flowchart of the steps involved in detecting anomalous data submissions using historical data profiles on a client device in a federated learning system, in accordance with one or more embodiments. For example, the system may use process 500 (e.g., as implemented on one or more system components described above) in order to detect anomalous data submissions using historical data profiles.

At step 502, process 500 (e.g., using one or more components described above), during a first interval of time, retrieves a plurality of data updates and a corresponding plurality of data profiles. The plurality of data updates may, for example, be meant as training data for a federated learning system. Each user profile in Data Update(s) 132 corresponds to a user system, and contains information described by a first set of features. The first set of features may contain categorical or quantitative variables, and values for such features may describe, for example for models predicting resource availability values, the user system's make and model, the user system's location, the membership of the user system in any networks, any allocations of resources to the user system, a length of time for which the user system has recorded resource consumption, an extent and frequency of resource consumption, and the number of instances of the user system's excessive resource consumption. Each user profile may correspond to a resource availability value indicating the current amount of resources that should be made available to or reserved for the user system, which may also be recorded in Data Update(s) 132 in association with the user profile. The system may retrieve a plurality of user profiles as a matrix including vectors of feature values for the first set of features and append to the end of each vector a resource consumption value.

In some embodiments, the system may, before retrieving data updates, process Data Update(s) 132 using a data cleansing process to generate a processed dataset. The data cleansing process may include standardizing data types, formatting and units of measurement, and removing duplicate data. The system may then retrieve vectors corresponding to user profiles from the processed dataset.

In some embodiments, the system may process Data Update(s) 132 to generate data profiles, each of which correspond to a data update. A data profile describing a data update (e.g., including a first set of features) may include descriptive statistics regarding the data update. For example, the data profile may include a vector of averages across the first set of features in the data update. For example, the data profile may include distributions of the first set of features in the data update. For example, the data profile may include a list of frequencies of null values for the first set of features. For example, the data profile may include a covariance matrix between the first set of features. In some embodiments, the data profile may additionally or alternatively project datasets in Data Update(s) 132 into an alternate coordinate system, for example using Embedding Map 136. In some embodiments, the system may receive Data Update(s) 132 as a stream of data updates over a period of time, each data update including a unique dataset, for example representing a snapshot of some evolving process such as a disease. Correspondingly, the plurality of data updates in Data Update(s) 132 represent changes to the training data for the local model over time.

At step 504, process 500 (e.g., using one or more components described above) generates a first data profile trend based on the plurality of data profiles, wherein the first data profile trend comprises an expectation value and a measure of variance. the system may process Data Update(s) 132 and/or its corresponding data profiles using an extrapolation model (e.g., Trend Generation Subsystem 122) to generate a data profile trend. The data profile trend may include an expectation value and a measure of variance. The expectation value may be a vector of real values corresponding to a set of features from the plurality of data updates and the plurality of data profiles. The measure of variance may be a vector of real values, where each value is derived from a standard deviation of a feature in the set of features. Therefore, the data profile trend may capture the expected values and expected variances for some or all of the features in the Data Update(s) 132 independently. This allows for the comparison of any incoming data update against each feature in the set of features, leading to a more accurate assessment of the source and type of any abnormalities in the incoming data update.

To generate the expectation value and the measure of variance, Trend Generation Subsystem 122 may use extrapolation machine learning models. For example, the extrapolation machine learning models may use algorithms like Bayesian regression, time-series regression and/or principal component analysis. The extrapolation machine learning models may take the data profiles of Data Update(s) 132 as input and may output predicted values for a set of features, each predicted value corresponding to a range of error. Thus, Trend Generation Subsystem 122 may take the predicted values as the expectation value, and the ranges of error as measures of variance. In some embodiments, the maximum value for a measure of variance may be limited as a percentile of the standard deviations of Data Update(s) 132.

In some embodiments, the data profile trend may be generated using topological data analysis. For example, Trend Generation Subsystem 122 may select a lens function to project the plurality of data profiles into a real-valued space. For example, Trend Generation Subsystem 122 may choose a real-valued embedding space with a set of dimensions different from those used in data profiles for Data Update(s) 132. Thus, data profiles may be represented using embeddings in a lower dimension while preserving similarity relations within the data profiles. Trend Generation Subsystem 122 may then select a cover function to partition the real-valued embedding space into a plurality of sectors. Each sector in the real-valued embedding space may contain data profile representations, which may be collected in sector datasets. The system can generate the data profile trend as a relational data structure, using the overlap relations between sector datasets.

At step 506, process 500 (e.g., using one or more components described above) receives a subsequent data update and a corresponding subsequent data profile. The subsequent data update may include the same set of features as the data updates in Data Update(s) 132 and be of the same format. The subsequent data profile may also be in the same format and correspond to the same features as the data profiles for Data Update(s) 132. The data profile may include, for example, average values for the set of features, variance for each of the features in the subsequent data update, among other descriptive statistics.

At step 508, process 500 (e.g., using one or more components described above) determines a measure of deviation based on the expectation value of the first data profile trend and the subsequent data profile. For example, if the expectation value is a vector of predicted values from extrapolation machine learning models, Deviation Subsystem 124 may compare the average values for the set of features in the subsequent data profile against the expectation value to generate the measure of deviation, where the measure of deviation is a vector of values capturing the numerical difference between the expectation value and the subsequent data profile in each feature. In some embodiments, the data profile trend is a relational data structure constructed using a lens function and a cover function which partition data profile representations into sector datasets. Deviation Subsystem 124 may project the subsequent data profile into the real-valued embedding space using the lens function. Then, using the cover function, Deviation Subsystem 124 may assign the subsequent data profile to a first sector dataset associated with a first sector. Using the first sector dataset, the position of the subsequent data profile's representation within the first sector dataset, and the data profile trend, Deviation Subsystem 124 may determine a measure of deviation for the subsequent data profile. For example, the data profile trend may inform Deviation Subsystem 124 whether the first sector dataset contains outliers and/or the degree of separation from the first sector dataset to the relational data structure. In some embodiments, the measure of deviation of the subsequent data profile may be a vector, each value within which indicates a degree of deviation in one feature in the set of features in the subsequent data update. In other embodiments, the measure of deviation of the subsequent data profile may be a single real value.

At step 510, process 500 (e.g., using one or more components described above) generates an anomaly score based on the measure of deviation and the measure of variance. In some embodiments, the measure of deviation and the measure of variance are both vectors, each value in which corresponds to a feature in the subsequent data update. Anomaly Score Subsystem 126 may use a clustering machine learning model to process the measure of deviation and the measure of variance to generate the anomaly score. For example, the clustering model may take the measure of deviation, the expectation value and the measure of variance as input and generate as output a numerical score (the anomaly score) indicating the extent to which the measure of deviation falls within the measure of variance. The clustering model may use algorithms such as logistic regression, neural networks, and naïve bayes. In other embodiments, the measure of deviation and the measure of variance are both real values. Anomaly Score Subsystem 126 may determine the anomaly score to be a mathematical calculation based on the measure of deviation and the measure of variance (e.g., a proportion of the measure of deviation in the measure of variance.

At step 512, process 500 (e.g., using one or more components described above) based on the anomaly score, determines whether to label the subsequent data update as acceptable for inclusion in training data to generate a local model. For example, the system may receive an anomaly threshold from a central node of the federated learning system. The anomaly threshold may be a real value indicative of a benchmark degree of anomaly, beyond which data updates are to be rejected. If the anomaly score determined for the subsequent data update exceeds the anomaly threshold, the system may label the subsequent data update as unacceptable for inclusion in training data to generate a local model. Then the system may remove the subsequent data update and the subsequent data profile from a memory of the client device and train the local model based on Data Update(s) 132. If the anomaly score determined for the subsequent data update is less than the anomaly threshold, the system may use the subsequent data update for training the local model

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
A1. A system for detecting anomalous data updates in a federated learning system, comprising: receiving a plurality of data updates from one or more client devices in a federated learning system, wherein each data update includes data in a first real-valued space; processing, using a lens function, the plurality of data updates to project the plurality of data updates into a second real-valued space, wherein data in the first real-valued space corresponds to a data representation in the second real-valued space; processing, using a cover function, data representations in the second real-valued space corresponding to the plurality of data updates to partition the data representations in the second real-valued space into a plurality of sectors; generating a plurality of sector datasets corresponding to the plurality of sectors, wherein each sector dataset includes data representations included in a corresponding sector; processing, using a cluster function, the plurality of sector datasets to generate a relational data structure, wherein the relational data structure comprises a plurality of clusters, and wherein each cluster in the plurality of clusters includes data representations from one or more sector datasets from the plurality of sector datasets; determining, using the relational data structure, one or more anomalous data updates corresponding to one or more outliers, wherein the one or more outliers include data representations further than a distance threshold from a cluster in the plurality of clusters in the relational data structure; selecting a permissible set of data updates from the plurality of data updates by removing the one or more anomalous data updates; and training the federated learning system using the permissible set of data updates.
A2. A method for detecting anomalous data submissions, comprising: receiving a plurality of data updates, wherein each data update contains data in a first real-valued space; selecting a first function to project the plurality of data updates into a second real-valued space; selecting a second function to partition the second real-valued space into a plurality of sectors; generating a plurality of sector datasets associated with the plurality of sectors; processing the plurality of sector datasets to generate a relational data structure; and determining one or more outliers in the relational data structure corresponding to anomalous data updates.
A3. A method comprising: receiving a plurality of data updates, wherein each data update contains data in a first real-valued space; selecting a first function to project the plurality of data updates into a second real-valued space; selecting a second function to partition the second real-valued space into a plurality of sectors; generating a plurality of sector datasets associated with the plurality of sectors; using the plurality of sector datasets, determining one or more anomalous data updates corresponding to one or more outliers; and removing the one or more anomalous data updates from the plurality of data updates.
A4. The method of any one of the preceding embodiments, wherein the relational data structure comprises a set of clusters comprising data in the first real-valued space from the plurality of data updates.
A5. The method of any one of the preceding embodiments, wherein using the relational data structure to detect anomalous data updates comprises: selecting a distance threshold based on the relational data structure; labelling as outliers data representations further than the distance threshold from a cluster in the set of clusters in the relational data structure; selecting a percentage to be a normalcy threshold; and determining data updates with a proportion of outliers higher than the normalcy threshold to be anomalous.
A6. The method of any one of the preceding embodiments, wherein the first function may generate a data profile for an update dataset, comprising: one or more distributions of features in the update dataset; a frequency of null values for one or more features; a covariance matrix between features in the update dataset; and metadata regarding the update dataset.
A7. The method of any one of the preceding embodiments, wherein the first function may further process the data profile, comprising: using a first machine learning model, processing the one or more distributions of features, the frequency of null values, the covariance matrix, and metadata to generate a representation vector, wherein the representation vector is in the second real-valued space.
A8. The method of any one of the preceding embodiments, wherein the first function may recombine a first set of features of data in a data update into a second set of features, comprising: generating a covariance matrix based on the first set of features; computing a set of eigenvectors for the covariance matrix; selecting a measure of coverage and selecting a subset of eigenvectors from the set of eigenvectors based on the measure of coverage; and determining the second set of features corresponding to the subset of eigenvectors.
A9. The method of any one of the preceding embodiments, wherein partitioning the second real-valued space into the plurality of sectors comprises: generating a plurality of regions in the second real-valued space, wherein each region in the plurality of regions is defined by boundary parameters, and wherein each region in the plurality of regions is of uniform length and size; for each region in the plurality of regions, determining a density of data in the region to compare against a threshold density; and for each region in the plurality of regions, expanding the boundary parameters of the region such that density of data in the region meets the threshold density.
A10. The method of any one of the preceding embodiments, wherein partitioning the second real-valued space into the plurality of sectors comprises: generating a plurality of regions in the second real-valued space, wherein each region in the plurality of regions is defined by boundary parameters, and wherein each region in the plurality of regions is of uniform length and size; determining a plurality of overlap data among the plurality of regions, wherein overlap data belong to more than one region in the plurality of regions; for each region in the plurality of regions, determining a proportion of data that is overlap data to compare against a threshold proportion; and for each region in the plurality of regions, expanding the boundary parameters of the region such that proportion of data that is overlap data in the region meets the threshold proportion.
A11. The method of any one of the preceding embodiments, wherein generating the plurality of sector datasets associated with the plurality of sectors comprises: for each sector in the plurality of sectors, projecting the data in the sector from the second real-valued space into the first real-valued space; and generating the plurality of sector datasets to correspond to the plurality of sectors, wherein each sector dataset contains data in a corresponding sector projected into the first real-valued space.
A12. The method of any one of the preceding embodiments, wherein processing the plurality of sector datasets to generate the relational data structure comprises: retrieving a second machine learning model, wherein the second machine learning model is trained to cluster data in a dataset in the first real-valued space into one or more clusters; using the second machine learning model, clustering data in each sector into one or more clusters; and generating the relational data structure, comprising one or more nodes and one or more edges, wherein each node corresponds to a cluster in the one or more clusters, and wherein each edge between two clusters represents data belonging to both clusters.
A13. A tangible, non-transitory, machine-readable medium storing instructions that, when executed by a data processing apparatus, cause the data processing apparatus to perform operations comprising those of any of embodiments 1-12.
A14. A system comprising one or more processors; and memory storing instructions that, when executed by the processors, cause the processors to effectuate operations comprising those of any of embodiments 1-12.
A15. A system comprising means for performing any of embodiments 1-12.
B1. A system for detecting anomalous data updates at a client device in federated learning, comprising the client device including: one or more processors; and a non-transitory, computer-readable medium storing instructions that, when executed by the one or more processors, cause operations comprising: in response to receiving a first data update associated with a first interval of time and a second data update associated with a second interval of time, generating a first data profile based on the first data update and a second data profile based on the second data update, wherein each data profile comprises descriptive statistics regarding a data update comprising one or more of distributions of features in the data update, a frequency of null values, or a covariance matrix between features in the data update; processing, using an extrapolation model, the first data profile and the second data profile to generate a data profile trend, wherein the data profile trend comprises an expectation value and a measure of variance; in response to receiving a third data update associated with a third interval of time subsequent to the first interval of time and the second interval of time, generating a third data profile based on the third data update; determining a measure of deviation for the third data profile based on the expectation value of the data profile trend and the third data profile, wherein the measure of deviation is indicative of a difference between the third data profile and the expectation value; processing the measure of deviation and the measure of variance using a prediction model to generate an anomaly score; determining, based on the anomaly score, whether to include the third data update into training data for a local model to be trained at the client device; and in response to determining to include the third data update: training, based on the third data update, the local model to generate a set of model weights; and in response to receiving, from a central node, a request for the set of model weights, transmitting the set of model weights to the central node for federated learning.
B2. A method for detecting anomalous data updates on a client device in a federated learning system, comprising: during a first interval of time, retrieving a plurality of data updates and a corresponding plurality of data profiles; generating a first data profile trend based on the plurality of data profiles, wherein the first data profile trend comprises an expectation value and a measure of variance; receiving a subsequent data update and a corresponding subsequent data profile; determining a measure of deviation based on the expectation value of the first data profile trend and the subsequent data profile; generating an anomaly score based on the measure of deviation and the measure of variance; and based on the anomaly score, determining whether to label the subsequent data update as acceptable for inclusion in training data to generate a local model.
B3. A method comprising: during a first interval of time, retrieving a plurality of data updates and a corresponding plurality of data profiles; generating a first data profile trend based on the plurality of data profiles, wherein the first data profile trend comprises an expectation value and a measure of variance; receiving a subsequent data update and a corresponding subsequent data profile; determining a measure of deviation based on the expectation value of the first data profile trend and the subsequent data profile; and based on comparing the measure of deviation and the measure of variance, determining whether to label the subsequent data update as acceptable for inclusion in training data to generate a local model.
B4. The method of any one of the preceding embodiments, wherein generating the first data profile trend comprises: selecting a lens function to project the plurality of data profiles into a real-valued space; selecting a cover function to partition the real-valued space into a plurality of sectors; generating a plurality of sector datasets associated with the plurality of sectors; and processing the plurality of sector datasets to generate the first data profile trend, wherein the first data profile trend is a relational data structure.
B5. The method of any one of the preceding embodiments, wherein determining a measure of deviation based on the expectation value of the first data profile trend and the subsequent data profile comprises: using the lens function, projecting the subsequent data profile into the real-valued space; using the cover function, assigning the subsequent data profile to a first sector dataset associated with a first sector; and using the first sector and the first data profile trend, determining the measure of deviation.
B6. The method of any one of the preceding embodiments, wherein generating the first data profile trend comprises: using a first extrapolation machine learning model, processing the plurality of data profiles to generate the expectation value, wherein the first extrapolation machine learning model comprises a Bayesian regression algorithm; and using a second extrapolation machine learning model, processing the plurality of data profiles to generate the measure of variance, wherein the first extrapolation machine learning model comprises a principal component analysis algorithm.
B7. The method of any one of the preceding embodiments, wherein generating the anomaly score based on the measure of deviation and the measure of variance comprises: using a clustering machine learning model, processing the measure of deviation and the measure of variance to generate the anomaly score.
B8. The method of any one of the preceding embodiments, wherein determining whether to label the subsequent data update as acceptable for inclusion in training data to generate a local model comprises: receiving, from a central node of the federated learning system, an anomaly threshold, wherein the anomaly threshold is a predetermined real value; and comparing the anomaly score to the anomaly threshold.
B9. The method of any one of the preceding embodiments, wherein a first data profile in the plurality of data profiles comprises descriptive statistics, comprising: a vector, wherein each value in the vector represents an average of a feature in a set of features in a first data update, wherein the first data profile corresponds to the first data update; distributions of the set of features in the data update; a frequency of null values for the set of features; and a covariance matrix between the set of features.
B10. The method of any one of the preceding embodiments, wherein: the expectation value is a vector of real values corresponding to a set of features, wherein the set of features is associated with the plurality of data updates and the plurality of data profiles; and the measure of variance is a vector of real values, wherein each value in the measure of variance is derived from a standard deviation of a feature in the set of features.
B11. The method of any one of the preceding embodiments, wherein: determining, based on the anomaly score, not to include the subsequent data update into training data for a local model to be trained at the client device; removing the subsequent data update and the subsequent data profile from a memory of the client device; and training the local model based on the plurality of data updates.
B12. A tangible, non-transitory, machine-readable medium storing instructions that, when executed by a data processing apparatus, cause the data processing apparatus to perform operations comprising those of any of embodiments 1-12.
B13. A system comprising one or more processors; and memory storing instructions that, when executed by the processors, cause the processors to effectuate operations comprising those of any of embodiments 1-12.
B14. A system comprising means for performing any of embodiments 1-12.

What is claimed is:

1. A system for detecting anomalous data updates at a client device in federated learning, comprising the client device including:
one or more processors; and
a non-transitory, computer-readable medium storing instructions that, when executed by the one or more processors, cause operations comprising:
in response to receiving a first data update associated with a first interval of time and a second data update associated with a second interval of time, generating a first data profile based on the first data update and a second data profile based on the second data update, wherein each data profile comprises descriptive statistics regarding a data update comprising one or more of distributions of features in the data update, a frequency of null values, or a covariance matrix between features in the data update;
processing, using an extrapolation model, the first data profile and the second data profile to generate a data profile trend, wherein the data profile trend comprises an expectation value and a measure of variance;
in response to receiving a third data update associated with a third interval of time subsequent to the first interval of time and the second interval of time, generating a third data profile based on the third data update;
determining a measure of deviation for the third data profile based on the expectation value of the data profile trend and the third data profile, wherein the measure of deviation is indicative of a difference between the third data profile and the expectation value;
processing the measure of deviation and the measure of variance using a prediction model to generate an anomaly score;
determining, based on the anomaly score, whether to include the third data update into training data for a local model to be trained at the client device; and
in response to determining to include the third data update:
training, based on the third data update, the local model to generate a set of model weights; and
in response to receiving, from a central node, a request for the set of model weights, transmitting the set of model weights to the central node for federated learning.

2. The system of claim 1, wherein the central node compares the anomaly score against an anomaly threshold predetermined by the central node to determine whether to include the set of model weights into a central model at the central node.

3. The system of claim 1, comprising:
determining, based on the anomaly score, not to include the third data update into training data for a local model to be trained at the client device;
removing the third data update and the third data profile from a memory of the client device; and
training the local model based on the first data update and the second data update.

4. A method for detecting anomalous data updates on a client device in a federated learning system, comprising:
during a first interval of time, retrieving a plurality of data updates and a corresponding plurality of data profiles;
generating a first data profile trend based on the plurality of data profiles, wherein the first data profile trend comprises an expectation value and a measure of variance;
receiving a subsequent data update and a corresponding subsequent data profile;
determining a measure of deviation based on the expectation value of the first data profile trend and the subsequent data profile;
generating an anomaly score based on the measure of deviation and the measure of variance; and
based on the anomaly score, determining whether to label the subsequent data update as acceptable for inclusion in training data to generate a local model.

5. The method of claim 4, wherein generating the first data profile trend comprises:
selecting a lens function to project the plurality of data profiles into a real-valued space;
selecting a cover function to partition the real-valued space into a plurality of sectors;
generating a plurality of sector datasets associated with the plurality of sectors; and
processing the plurality of sector datasets to generate the first data profile trend, wherein the first data profile trend is a relational data structure.

6. The method of claim 5, wherein determining a measure of deviation based on the expectation value of the first data profile trend and the subsequent data profile comprises:
using the lens function, projecting the subsequent data profile into the real-valued space;
using the cover function, assigning the subsequent data profile to a first sector dataset associated with a first sector; and
using the first sector and the first data profile trend, determining the measure of deviation.

7. The method of claim 4, wherein generating the first data profile trend comprises:
using a first extrapolation machine learning model, processing the plurality of data profiles to generate the expectation value, wherein the first extrapolation machine learning model comprises a Bayesian regression algorithm; and
using a second extrapolation machine learning model, processing the plurality of data profiles to generate the measure of variance, wherein the first extrapolation machine learning model comprises a principal component analysis algorithm.

8. The method of claim 4, wherein generating the anomaly score based on the measure of deviation and the measure of variance comprises:
using a clustering machine learning model, processing the measure of deviation and the measure of variance to generate the anomaly score.

9. The method of claim 4, wherein determining whether to label the subsequent data update as acceptable for inclusion in training data to generate the local model comprises:
receiving, from a central node of the federated learning system, an anomaly threshold, wherein the anomaly threshold is a predetermined real value; and
comparing the anomaly score to the anomaly threshold.

10. The method of claim 4, wherein a first data profile in the plurality of data profiles comprises descriptive statistics, comprising:
a vector, wherein each value in the vector represents an average of a feature in a set of features in a first data update, wherein the first data profile corresponds to the first data update;
distributions of the set of features in the data update;
a frequency of null values for the set of features; and
a covariance matrix between the set of features.

11. The method of claim 4, wherein:
the expectation value is a vector of real values corresponding to a set of features, wherein the set of features is associated with the plurality of data updates and the plurality of data profiles; and
the measure of variance is a vector of real values, wherein each value in the measure of variance is derived from a standard deviation of a feature in the set of features.

12. The method of claim 4, wherein:
determining, based on the anomaly score, not to include the subsequent data update into training data for a local model to be trained at the client device;
removing the subsequent data update and the subsequent data profile from a memory of the client device; and
training the local model based on the plurality of data updates.

13. A non-transitory, computer-readable medium comprising instructions recorded thereon that when executed by one or more processors causes operations comprising:
during a first interval of time, retrieving a plurality of data updates and a corresponding plurality of data profiles;
generating a first data profile trend based on the plurality of data profiles, wherein the first data profile trend comprises an expectation value and a measure of variance;
receiving a subsequent data update and a corresponding subsequent data profile;
determining a measure of deviation based on the expectation value of the first data profile trend and the subsequent data profile; and
based on comparing the measure of deviation and the measure of variance, determining whether to label the subsequent data update as acceptable for inclusion in training data to generate a local model.

14. The non-transitory computer-readable medium of claim 13, wherein generating the first data profile trend comprises:
selecting a lens function to project the plurality of data profiles into a real-valued space;
selecting a cover function to partition the real-valued space into a plurality of sectors;
generating a plurality of sector datasets associated with the plurality of sectors; and
processing the plurality of sector datasets to generate the first data profile trend, wherein the first data profile trend is a relational data structure.

15. The non-transitory computer-readable medium of claim 14, wherein determining a measure of deviation based on the expectation value of the first data profile trend and the subsequent data profile comprises:
using the lens function, projecting the subsequent data profile into the real-valued space;
using the cover function, assigning the subsequent data profile to a first sector dataset associated with a first sector; and
using the first sector and the first data profile trend, determining the measure of deviation.

16. The non-transitory computer-readable medium of claim 13, wherein generating the first data profile trend comprises:
using a first extrapolation machine learning model, processing the plurality of data profiles to generate the expectation value, wherein the first extrapolation machine learning model comprises a Bayesian regression algorithm; and
using a second extrapolation machine learning model, processing the plurality of data profiles to generate the measure of variance, wherein the first extrapolation machine learning model comprises a principal component analysis algorithm.

17. The non-transitory computer-readable medium of claim 13, further comprising generating an anomaly score based on the measure of deviation and the measure of variance, comprising:
using a clustering machine learning model, processing the measure of deviation and the measure of variance to generate the anomaly score.

18. The non-transitory computer-readable medium of claim 17, wherein determining whether to label the subsequent data update as acceptable comprises:
receiving, from a central node of a federated learning system, an anomaly threshold, wherein the anomaly threshold is a predetermined real value; and
comparing the anomaly score to the anomaly threshold.

19. The non-transitory computer-readable medium of claim 13, wherein a first data profile in the plurality of data profiles comprises descriptive statistics, comprising:
a vector, wherein each value in the vector represents an average of a feature in a set of features in a first data update, wherein the first data profile corresponds to the first data update;
distributions of the set of features in the data update;
a frequency of null values for the set of features; and
a covariance matrix between the set of features.

20. The non-transitory computer-readable medium of claim 13, wherein:
the expectation value is a vector of real values corresponding to a set of features, wherein the set of features is associated with the plurality of data updates and the plurality of data profiles;
the measure of variance is a vector of real values, wherein each value in the measure of variance is derived from a standard deviation of a feature in the set of features.
